(19) United States
(12) Patent Application Publication
(10) Pub. No.: US 2008/0238143 A1
(43) Pub. Date: Oct. 2, 2008

(54) Motor Vehicle Comprising a Spray Water Container

(75) Inventors: Mattias Geyrhofer, Worrstadt (DE); Patrick Verhee, Koln (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/065,937

(22) PCT Filed: Sep. 12, 2006
(86) PCT No.: PCT/EP2006/008835

§ 371 Date: Mar. 6, 2008

(30) Foreign Application Priority Data
Sep. 16, 2005 (DE) 102005044286.2

(51) Int. Cl. B60R 27/00

(52) U.S. Cl. 296/187.03

(57) ABSTRACT

Motor vehicle with a water spray reservoir (10) which is accommodated in the front end (20) of the vehicle between outer skin (S) and units (M) and is positioned on the front structure (21) of the vehicle so that the reservoir (10) opposes an impact with the lowest possible resistance.

The invention relates to a motor vehicle with a water spray reservoir according to claim 1.

Water spray reservoirs in motor vehicles are usually integrated in the side region of the front of the vehicle to make it easier to top up the water. At the same time, the reservoirs are positioned as close to the windscreen as possible to ensure a short connection to the nozzles of the windscreen washer unit.

In future, greater spacings will be required in the front region of vehicles between the outer skin and units, which spacings are to meet the forthcoming regulations of the new pedestrian protection law. To avoid a complete redesign of current vehicles, in particular lengthening the front end, provision is made to change the position of the radiator system, for example to the side of or above the engine etc. Consequently, a deformation zone is produced in the front centre of the vehicle which makes this region more flexible for a potential frontal impact. On the other hand, this leads to an inefficient use of installation space, since the packing density of components in other parts of the front of the vehicle increases, which complicates their assembly as well as their maintenance, which leads to rising costs.

The object of the present invention is to develop a vehicle with a water spray reservoir such that an improved impact protection is achieved simultaneously with an efficient utilisation of installation space and which, at the same time, is simple and economic to produce. It is also the object of the present invention to provide a water spray reservoir suitable for this purpose.

This object is achieved by a vehicle wherein the water spray reservoir is accommodated between the outer skin and units in the front end of said vehicle and is positioned on the front structure of said vehicle such that the reservoir opposes an impact with as little resistance as possible.

A fundamental point of the relocation according to the invention of the water spray reservoir is that the space usually occupied by the reservoir in the part of the front of the vehicle on the passenger-area side is now available for other components, thereby easing the packing density. At the same time, a zone free of units in the front region of the vehicle is ensured, which meets the requirements of the new pedestrian protection law for sufficient deformation space in this area. The accommodation of the water for spraying does not routinely require any particularly dimensionally stable construction either, so that this can be produced, for example from a resilient plastics material for the sufficiently flexible shaping of the impact region. Relocating the water spray reservoir to the front structure of the front end is also easy to accomplish in constructional terms and is accordingly cost-effective. The water filler of a reservoir positioned at the front is also more easily accessible for a user.

Preferred developments of the vehicle are provided in subclaims 2 and 3.

An advantageous embodiment provides that the water spray reservoir is positioned below an upper cross member of the front structure. In the event of a head-on collision, the resistance of the reservoir is thereby very low, as it is able to be deflected out of the way, without being obstructed, to the side of the units below the cross member. However, in principle an arrangement is also possible above the cross member if the spacing between cross member and bonnet allows this. In any case, a free length is maintained between outer skin and, for example, engine, which is not curtailed by the reservoir more than by the cross member itself. Thus, the impact safety is not restricted by the arrangement of the reservoir.

If the water spray reservoir extends over the cantilevered length of the upper cross member, its mass is distributed over the width of the vehicle and does not form an impact obstacle at a particular point in the front region. At the same time, the reservoir extended in this manner can hold a suitably large amount of water for spraying.

Preferred embodiments of the water spray reservoir are disclosed in subclaims 4 to 11.

In order on the one hand to ensure a secure suspension of the water spray reservoir, and on the other hand to provide the reservoir with a continuous suspension which is not too rigid over its entire length, it has upper attachment flanges for joining with the upper cross member of the front structure.

The water spray reservoir can also be provided with lower attachment flanges for joining with a lower cross member of the front structure with which it would be mounted in a vibration-free manner between two cross members. At the same time, a free length between the outer skin and the engine is not restricted by the reservoir beyond the length already claimed by the cross member.

In order to ensure an easy releasability of the water spray reservoir from its suspension, its attachment flanges have predetermined breaking points which, in the event of a head-on collision, allow the water spray reservoir to be detached from at least one of the cross members. A reservoir released in this manner no longer affords any appreciable resistance.

In this arrangement, the predetermined breaking points are preferably configured only on the attachment flanges extending transversely to the direction of travel. The impact load absorbed there gives rise to shearing forces which, in conjunction with the predetermined breaking points, result in a particularly rapid tear-off detachment of the flange. The reservoir thus no longer presents any decisive resistance with low deformations of the front end.

Although a considerable impact protection is already provided by the arrangement and suspension of the water spray reservoir at the front end, it is advantageous if the reservoir has collapsible wall elements which allow the reservoir to deform in a head-on collision. Consequently, the reservoir can be compressed, for example in the sense of an accordion, thereby adding to the yielding configuration of the impact region.

The wall elements are preferably configured around the water spray reservoir approximately perpendicularly to the direction of travel. The greatest load effect is to be usually assumed approximately transversely to the path of the wall elements, so that with this arrangement a particularly marked shortening of the reservoir will also occur.

The deformation of the water spray reservoir is facilitated in that the reservoir has a relief valve which opens when there is excess pressure in the reservoir, i.e. during its compression in the course of an impact.

The relief valve is preferably configured on the lower side of the reservoir to ensure a rapid discharge of the uncompressible water.

The deformation of the water spray reservoir is further facilitated by the fact that the reservoir is produced from a resilient plastics material.

The invention will be described in more detail in the following using an embodiment with reference to the respective drawings. Identical part or parts with an identical function have been given the same reference numerals. In the drawings:

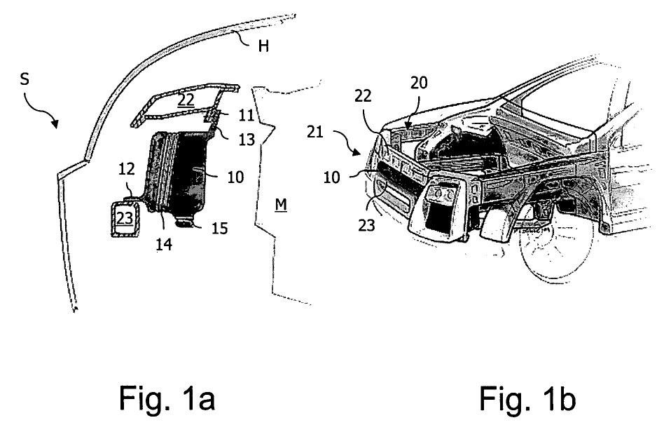

FIG. 1a is a cross-sectional view of the front end of a motor vehicle according to the invention to illustrate the suspension and configuration of a water spray reservoir on the front structure of the vehicle, and

FIG. 1b is a perspective view of the vehicle of FIG. 1a, to illustrate the position and extent of the water spray reservoir in its front end.

FIG. 1a is a cross-sectional view of the front end 20 (denoted in FIG. 1b) of a motor vehicle according to the invention, to illustrate the suspension and configuration of a water spray reservoir 10 on the front structure 21 (also denoted in FIG. 1b) of the vehicle. The reservoir 10 is suspended between an upper cross member 22 and a lower cross member 23 which extend in a deformation zone between a outer skin S (SKIN) and a unit, in this case an engine M (MOTOR) perpendicularly to the plane of the drawing. In the event of a head-on collision, the suspension allows the reservoir 10 to move to the side of the engine, which greatly reduces the resistance of the reservoir 10. The arrangement of the reservoir 10 below the cross member 22 does not reduce the free length between outer skin S and engine which would not already be shortened by the cross member 22 (or 23) itself. In this respect the impact safety is not reduced by the reservoir 10 positioned in this manner, but results in a more efficient utilisation of space in the part of the front of the vehicle on the occupant compartment side where the reservoir 10 is usually positioned. The requirements of the new pedestrian protection law are thus satisfied with a simultaneous efficient utilisation of space.

In principle, the reservoir 10 can also be positioned above the cross member 22 or below the lower cross member 23 to produce an identical moving-aside motion as described above.

In the present embodiment at least, the spacing between the upper cross member 22 and a bonnet H (HOOD) would be unsuitable for accommodating the reservoir 10. In this embodiment, the reservoir is therefore joined to the cross members 23, 23 by upper and lower flanges 11, 12 to also ensure that the reservoir 10 is mounted in as vibration-free manner as possible during vehicle operation. Tearing away of the reservoir 10 from the upper flange 13 extending approximately perpendicularly to the direction of travel is facilitated, in the event of a head-on collision, by a predetermined breaking point 13 which gives way very rapidly under the acting shearing forces. Furthermore, the reservoir 10 is provided with collapsible wall elements 14 which run approximately perpendicularly to the direction of travel, become compressed in the manner of an accordion in the event of a heavy impact and shorten the length of the reservoir 10. The reservoir 10 is thus also of a yielding design and can additionally be produced from a resilient plastics material. To further facilitate the deformation of the reservoir 10, a relief valve 15 is provided on its lower side which, under the impact load, ensures a rapid escape of the water for spraying.

FIG. 1b is a perspective view of the vehicle of FIG. 1a, to illustrate the position and extent of the water spray reservoir 10 in its front end 20. To avoid an impact obstacle at a particular point, the reservoir 10 extends over the entire self-supporting length of the upper cross member 22 of the front structure 21 and in addition, for the vibration-free mounting, is accommodated between this cross member 22 and the lower cross member 23 positioned thereunder. The reservoir 10 is thus reliably integrated into the front structure 21 of the vehicle with, at the same time, the lowest possible resistance to a head-on collision.

Overall, the inventive arrangement, suspension and configuration of a water spray reservoir in a motor vehicle allows the available installation space in the front of the vehicle to be used efficiently, while at the same time an assembly-free, flexible deformation zone is maintained which satisfies the regulations of the new pedestrian protection law.

### LIST OF REFERENCE NUMERALS

10 water spray reservoir
11 upper attachment flange
12 lower attachment flange
13 predetermined breaking points of flange 11
14 collapsible wall element
15 relief valve
20 front end of the vehicle
21 front structure of the front end 20
22 upper cross member
23 lower cross member
H bonnet
M engine

1. A motor vehicle with a water spray reservoir which is accommodated in the front end of the vehicle between outer skin and units and is positioned on the front structure of the vehicle so that the reservoir opposes an impact with the lowest possible resistance.

2. A motor vehicle according to claim 1, wherein the water spray reservoir is positioned below an upper cross member of the front structure (21).

3. A motor vehicle according to claim 2, wherein the water spray reservoir extends over the cantilevered length of the upper cross member.

4. A motor vehicle according to claim 2, wherein upper attachment flanges are formed for joining with the upper cross member of the front structure.

5. A motor vehicle according to claim 4, wherein lower attachment flanges are formed for joining with a lower cross member of the front structure.

6. A motor vehicle according to claim 4, wherein the attachment flanges have predetermined breaking points which, in the event of a head-on collision, allow the water spray reservoir to become detached from the upper cross member.

7. A motor vehicle according to claim 6, wherein the predetermined breaking points are formed only on the attachment flanges running approximately perpendicularly to the direction of travel.

8. A motor vehicle according to claim 1, wherein the water spray reservoir has collapsible wall elements which, in the event of a head-on collision, allow the reservoir to deform.

9. A motor vehicle according to claim 8, wherein the wall elements are configured around the water spray reservoir transversely to the direction of travel.

10. A motor vehicle according to claim 1, wherein the water spray reservoir has a relief valve which opens when there is excess pressure in the reservoir.

11. A motor vehicle according to claim 10, wherein the relief valve is formed on the lower side of the water spray reservoir.

12. A motor vehicle according claim 1, wherein the spray reservoir is produced from a resilient plastics material.
